(19) United States
(12) Patent Application Publication
(10) Pub. No.: US 2026/0213475 A1
(43) Pub. Date: Jul. 23, 2026

(54) POWER CONNECTOR WITH IMPROVED TERMINAL ASSEMBLIES

(71) Applicant: FOXCONN INTERCONNECT TECHNOLOGY LIMITED, Grand Cayman (KY)

(72) Inventor: YUNG-CHIH HUNG, New Taipei (TW)

(21) Appl. No.: 19/457,067

(22) Filed: Jan. 22, 2026

(30) Foreign Application Priority Data
Jan. 23, 2025 (CN) 202510112013.6

(51) Int. Cl. H01R 25/14; H01R 13/11; H01R 13/24; H01R 13/422; H01R 13/436; H01R 13/46; H01R 25/00

(52) U.S. Cl. CPC H01R 25/142; H01R 13/112; H01R 13/2457; H01R 13/4223; H01R 13/436; H01R 13/46; H01R 25/003

(57) ABSTRACT

A power connector includes: an insulating housing defining a mating direction, a first direction, and a second direction perpendicular to each other and including two sidewalls arranged in the first direction and having a mating slot opening forwards in the mating direction; and two terminal assemblies disposed at insides of the sidewalls respectively, each of the conductive assemblies including a conductive block, a group of terminal pieces stacked in the first direction, and a power cable or a bus bar; wherein each terminal piece includes a rear portion and plural elastic arms extending forwards from the rear portion and arranged in the second direction, the elastic arms having contacting portions protruding into the mating slot in the first direction; and the rear portions of the group of terminal pieces are fitly attached to corresponding conductive block, and the power cable or the bus bar is attached to corresponding conductive block.

### BACKGROUND OF THE INVENTION

### 1. Field of the Invention

The present invention relates to a power connector with improved terminal assemblies.

### 2. Description of Related Arts

U.S. Patent No. 11,837,825 discloses a connector including two terminal assemblies arranged opposite to and spaced apart. Each of terminal assemblies has a plate-shaped fixing portion, a terminal portion, and a laterally extending connection portion to connect the plate-shaped fixing portion and the first terminal portion. A spacing between the plate-shaped fixing portions is greater than a spacing between the terminal portions. A conductive block is laminated on an inner surface of the terminal portion of each of the terminal assemblies.

An improved electrical connector is desired.

### SUMMARY OF THE INVENTION

An object of the present invention is to provide a power connector with improved terminal assemblies.

To achieve the above-mentioned object, a power connector comprises: an insulating housing defining a mating direction, a first direction, and a second direction perpendicular to each other and comprising two sidewalls arranged in the first direction and having a mating slot opening forwards in the mating direction; and two terminal assemblies disposed at insides of the sidewalls respectively, each of the conductive assemblies comprising a conductive block, a group of terminal pieces stacked in the first direction, and a power cable or a bus bar; wherein each terminal piece comprises a rear portion and plural elastic arms extending forwards from the rear portion and arranged in the second direction, the elastic arms having contacting portions protruding into the mating slot in the first direction; and the rear portions of the group of terminal pieces are fitly attached to corresponding conductive block, and the power cable or the bus bar is attached to corresponding conductive block.

Other advantages and novel features of the invention will become more apparent from the following detailed description of the present embodiment when taken in conjunction with the accompanying drawings.

### BRIEF DESCRIPTION OF DRAWINGS

FIG. 1 is a perspective view of a power connector of an embodiment of the present application;

FIG. 2 is an exploded perspective view of the power connector shown in FIG. 1;

FIG. 3 is a perspective view of the conductive block and terminal pieces in FIG. 2;

FIG. 4 is another perspective view of FIG. 3;

FIG. 5 is another perspective view of FIG. 3;

FIG. 6 is a side view of FIG. 4;

FIG. 7 is a perspective view of a lower part in FIG. 4, to show the latches in the insulating housing;

FIG. 8 is an exploded perspective view of the insulating housing and the stopper in FIG. 1;

FIG. 9 is a cross-sectional view of the power connector taken along a line A-A in FIG. 1;

FIG. 10 is a perspective view of the power connector in FIG. 1 and a second connector;

FIG. 11 is a perspective view of the power connector and the second connector in FIG. 10 mated with each other; and

FIG. 12 is a partial perspective view of the terminal pieces and conductive block connecting with the second connector in FIG. 11.

### DETAILED DESCRIPTION OF THE PREFERRED EMBODIMENT

Reference will now be made to the drawing figures to describe a preferred embodiment of the present invention in detail.

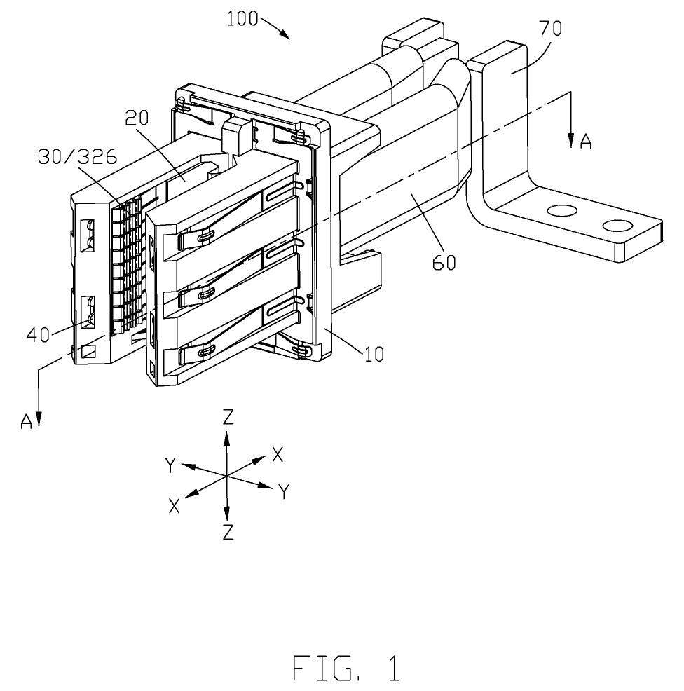

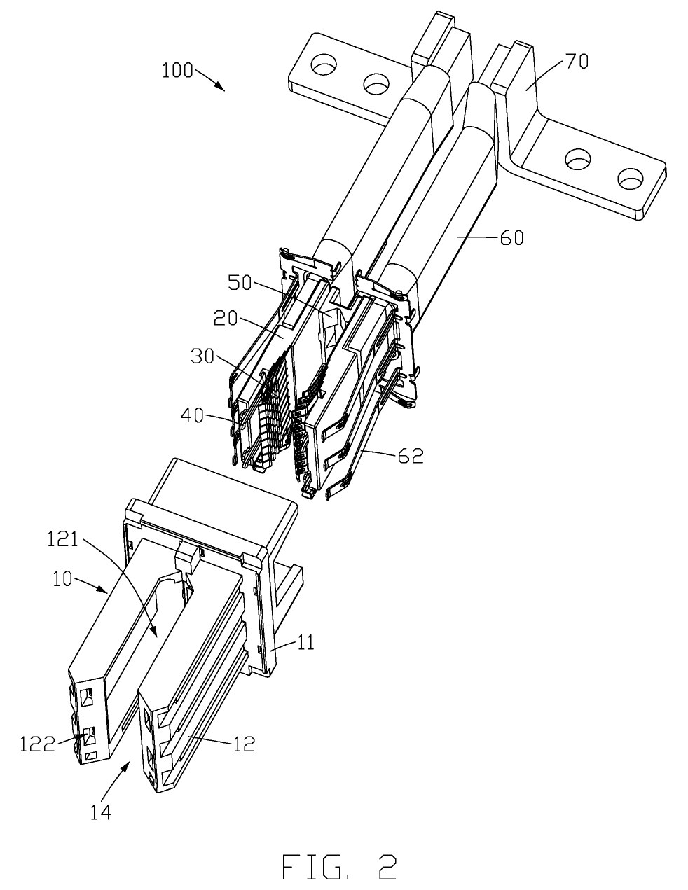

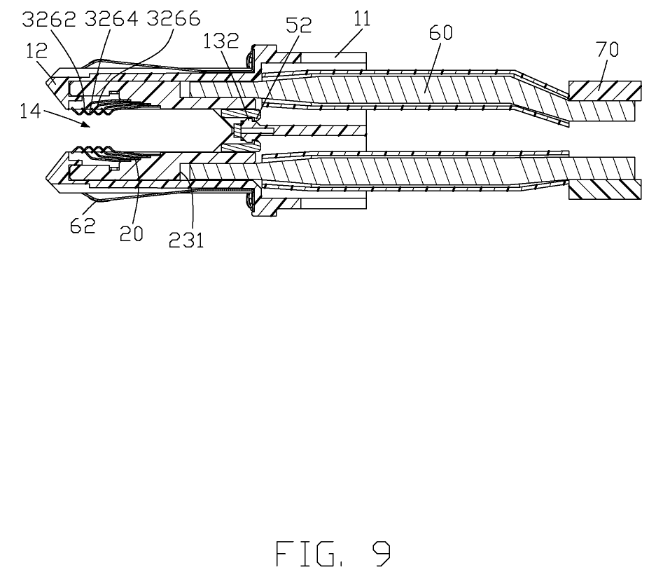

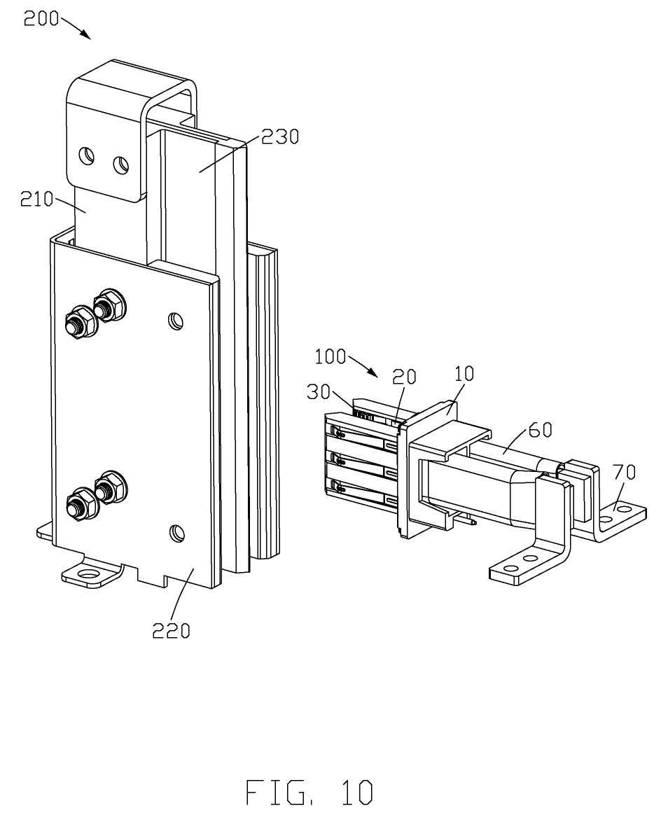

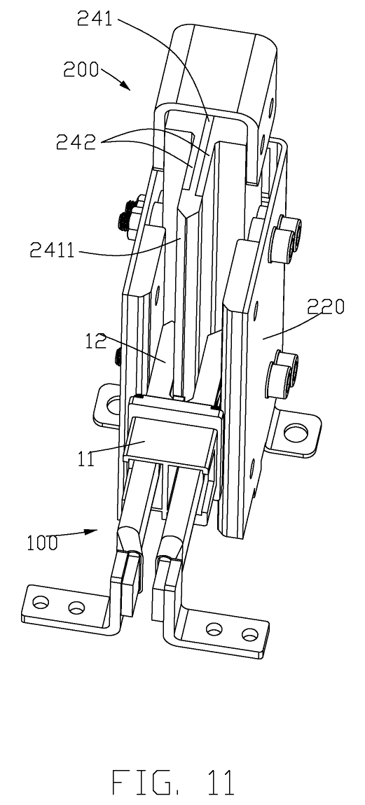

Referring to FIGS. 1 and 2, a power connector 100 of an embodiment of this invention may include an insulating housing 10, a pair of conductive blocks 20, and two groups of terminal pieces 30. The power connector 100 defines a mating direction X-X, a first direction Y-Y, and a second direction Z-Z perpendicular to each other. The insulating housing 10 may be made of a non-conductive insulating material, such as plastic. The insulating housing 10 may include a base portion 11 and a pair of sidewalls 12 extending forwards from the base portion 11 in the mating direction X-X. The two sidewalls 12 are symmetrically spaced to form a mating slot 14. The mating slot 14 opens forwards in the mating direction and used for being inserted with a bus bar or a power daughter card, such as two bus bars 242 of a second connector 200 as shown in FIGS. 10-11. In this embodiment, the mating slot 14 also opens in the second direction Z-Z, thereby the main bus bar extending upright. The mating slot 14 has a plug-stopping face 141 facing forward to stop a further insertion of the main bus bar, as clearly shown in FIG. 9. The base portion 11 is generally in the shape of a hollow rectangular body, and each sidewall 12 is generally in the shape of a rectangular plate.

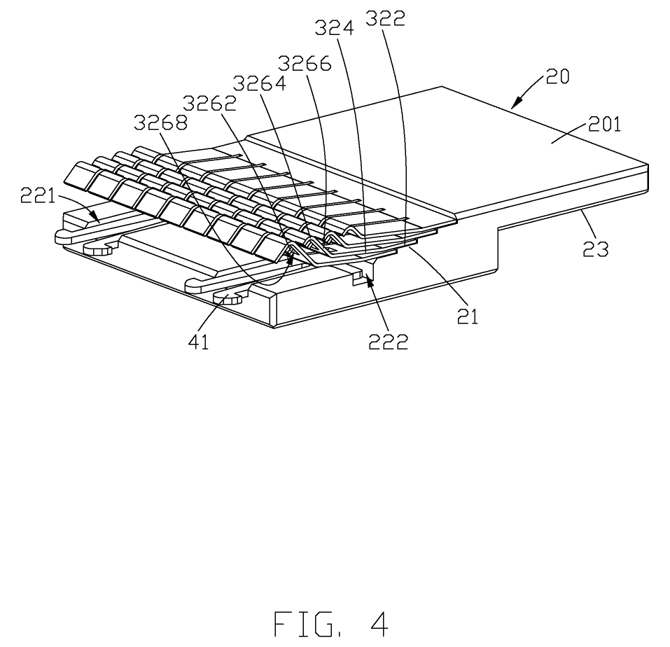

Referring to FIGS. 2-4, the two conductive blocks 20 are spaced apart and oppositely disposed on the opposing insides of the sidewalls 12. The two conductive blocks 20 are also spaced apart symmetrically and positioned on opposite sides of the mating slot 14. Each conductive block 20 has an inside 201 adjacent to the mating slot 14 and an outside 202 opposite to the inside 201. The conductive blocks 20 may be made of a conductive material, such as copper. The inside 201 of each conductive block 20 has a stepped portion 21 with plural stepped faces 211 parallel to each other while in different height in the first direction Y-Y.

The terminal pieces 30 of the group of terminal pieces are stacked in the first direction Y-Y and connected with the conductive block 20. The group of terminal pieces 30 are sequentially arranged along the mating direction X-X on the inside 202 of each conductive block 20. The two groups of terminal pieces 30 on the two conductive blocks 20 are symmetrically disposed, and the terminal pieces 30 are located at opposite sides of the mating slot 14 and elastically protrude toward the mating slot 14 in the first direction. The conductive blocks 20 extend forward in the mating direction beyond the foremost end of the terminal pieces 30. Each stepped portion 21 of the conductive blocks 20 is continuously and spacedly arranged with groups of terminal pieces 30, allowing the terminal pieces 30 to form a continuous and spaced arrangement along the mating direction. Every two adjacent terminal pieces 30 are spaced apart. Each terminal piece 30 may be an elastic metal sheet with elastic deformation and recovery capabilities. It can be understood that each terminal piece 30 may be integrally formed. The group of terminal pieces 30 and corresponding conductive block 20 at one side of the mating slot 14 transmit positive power forming a terminal assembly, while the group of terminal pieces 30 and corresponding conductive block 20 on another side of the mating slot 14 forming another terminal assembly to transmit negative power. In other embodiments, the groups of terminal pieces 30 and corresponding conductive blocks 20 on both sides of the mating slot 14 transmit positive power, and negative power requires an additional power connector for transmission. Each of the sidewalls 12 has a receiving cavity 121 at the inside thereof and opening rearwards in the mating direction, the terminal assemblies are inserted forwards into the receiving cavities 121 respectively.

Each of the conductive blocks 20 has a recessed portion 23 at a rear of the outside 201 thereof. The stepped portion 21 is located in front of the recessed portion 23 in the mating direction. The front side 231 of the recessed portion 23 is located in front of the plug-stopping face 141 of the mating slot 14 as best shown in FIG. 9. That is, the depth of the mating slot 14 in the mating direction is greater than the length of the conductive block 20.

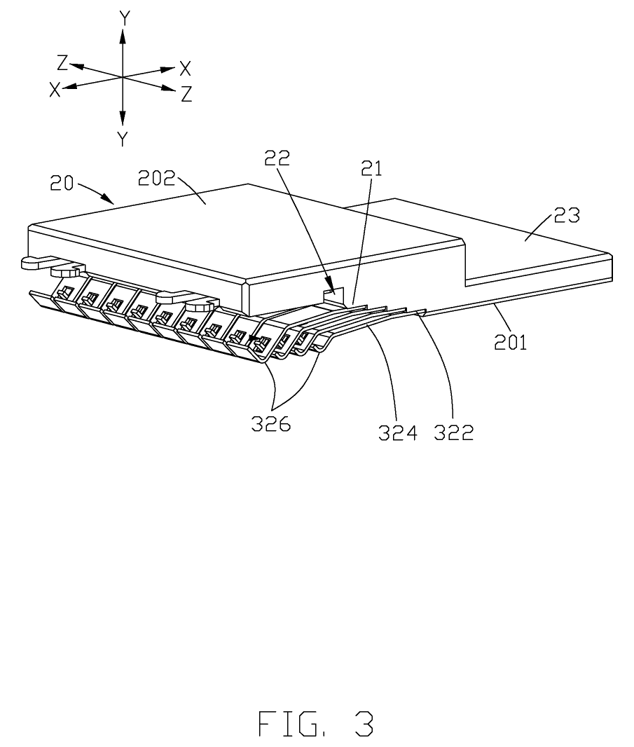

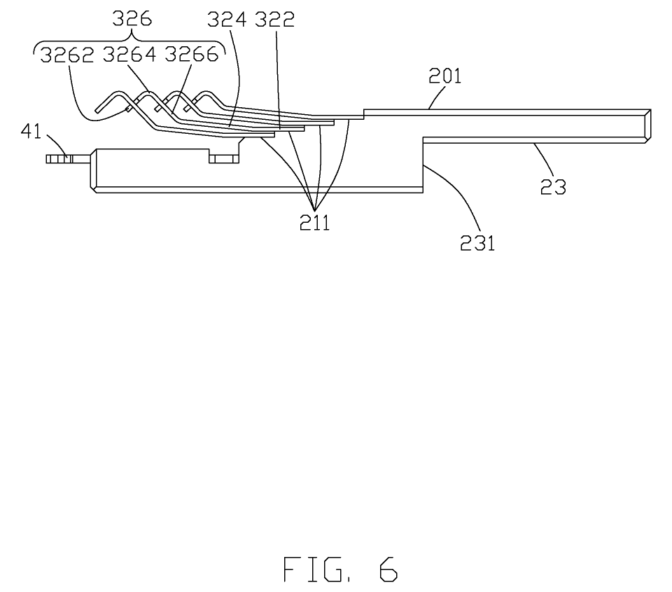

Referring to FIGS. 3-6, each terminal piece 30 includes a rear portion 322, plural elastic arms 324, the elastic arms have contacting portions 326. The rear portion 322 and the contacting portions 326 are respectively located at opposite ends of the elastic arms 324. The rear portion 322 is positioned on the stepped portion 21, and the plural elastic arms 324 are connected to the rear portion 322 and extend out of the stepped portion 21 and slightly tilting upward relative to the stepped portion 21. The elastic arms 324 of each terminal piece 30 may be spacedly arranged in the first direction. The contacting portion 326 is generally bent in shape, and tilts upward relative to the stepped portion 21. As a result, the contacting portion 326 extends forward along the mating direction and protrudes into the mating slot 14 in the first direction, allowing the contacting portion 326 to abut against the bus bars 242 inserted into the mating slot 14. Similarly, the elastic arms 324 of each terminal piece 30 and the elastic arms 324 of the adjacent terminal piece 30 can also be spaced apart. In other words, as clearly shown in FIG. 6, the stepped portion 21 has plural step faces 211. The rear portion 322 of each terminal piece is placed on the corresponding step face 211. The rear portion of the terminal piece located on the outer side is closer to the front, while the rear portion of the terminal piece located on the inner side is farther from the front.

In this embodiments, the contacting portion 326 includes a coupling tab 3262, a stopping or contacting face 3264, and a coupling face 3266. The coupling face 3266 is connected to the elastic arm 324. The coupling face 3266 has a coupling hole 3268. The contacting face 3264 and the coupling face 3266 are arranged at a predetermined angle. In some embodiments, the contacting face 3264 and the coupling face 3266 form a generally U-shaped or V-shaped structure, The contacting face 3264 can be used to abut against the bus bar 242 when the bus bars is inserted into the mating slot 14. The coupling tab 3262 is located at a front end of the contacting face 3264. The coupling tab 3262 extends from the contacting face 3264. The width of the coupling tab 3262 is smaller than the width of the contacting face 3264 in the second direction. Therefore, the coupling tab 3262 go across corresponding coupling hole 3268 of the adjacent terminal piece 30 when the elastic arms 324 move outwards in the first direction. The volume of the coupling tab 3262 is smaller than the area of the coupling hole 3268. When the terminal piece 30 undergoes elastic deformation, the coupling tab 3262 can move within the corresponding coupling hole 3268 without contacting the coupling face 3266, thereby preventing signal crosstalk between the terminal pieces 30. It can be understood that the terminal piece 30 at the foremost end in the mating direction may not have a coupling tab 3262.

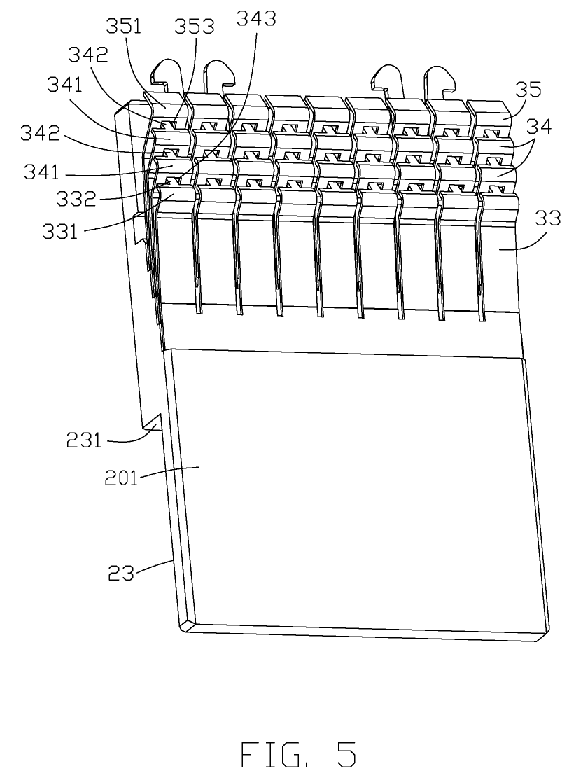

As best shown in FIG. 5, the group of terminal pieces 30 includes an innermost terminal piece 33, an outermost terminal piece 35, and at least one middle terminal piece 34. The innermost terminal piece 33 has a coupling tab 332 extending forwards from each of the contacting portion 331 thereof. The middle terminal piece has a coupling tab 342 extending forwards from each of the contacting portions 342 thereof, and a coupling hole 343 on each of the contacting portions 341 thereof to receive corresponding coupling tab 332 of innermost terminal piece 33. The outermost terminal piece 35 has a hole 353 at each of the contacting portions 351 thereof to receive corresponding coupling tab 342 of the middle terminal piece 34. In this embodiment, the at least one middle terminal piece 344 includes two middle terminal pieces. The coupling tabs go across corresponding coupling holes respectively when the power connector is not inserted with the power bus bar, i.e., in a nature state. Alternatively, the coupling tabs are located behind corresponding coupling hole in the nature state while the coupling tabs go through corresponding holes after the elastic arms are urged to move outwards in the first direction.

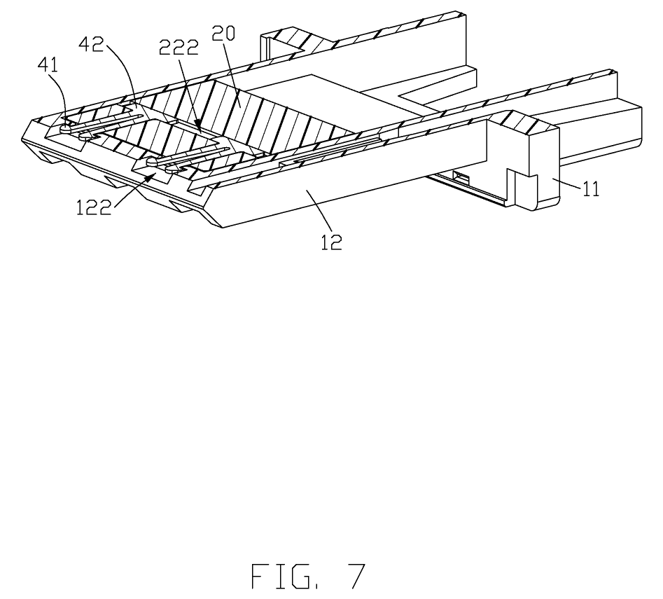

Referring to FIGS. 2 and 7, the power connector 100 may further include plural latches 40. The inside 201 of each conductive block 20 also has two first grooves 221 arranged in the second direction and each extending in the mating direction. Each sidewall 12 of the insulating housing 10 may have two locking holes 122. The locking holes 122 may begin at the position on each sidewall 12 corresponding to the front end of the conductive block 20. The number of latches 40, the number of grooves 221, and the number of holes 122 correspond to each other. The latch 40 is fixed in corresponding first groove 221, and the front end of each latch 40 is latched into the corresponding locking hole 122. The conductive blocks 20 can be better secured to the sidewalls 12 of the insulating housing 10 via the latches 40. In this embodiment, the latch 40 has a bar 42 and a forked hook 41 extending forward from the bar 42, the forked hooks 41 are locked with the locking holes 122 on the sidewall. The sidewall 12 has a second groove 222 extending in the second direction, the bars 42 are retained in the second groove 222. The first and the second grooves form a receiving groove 22 for the latches 40.

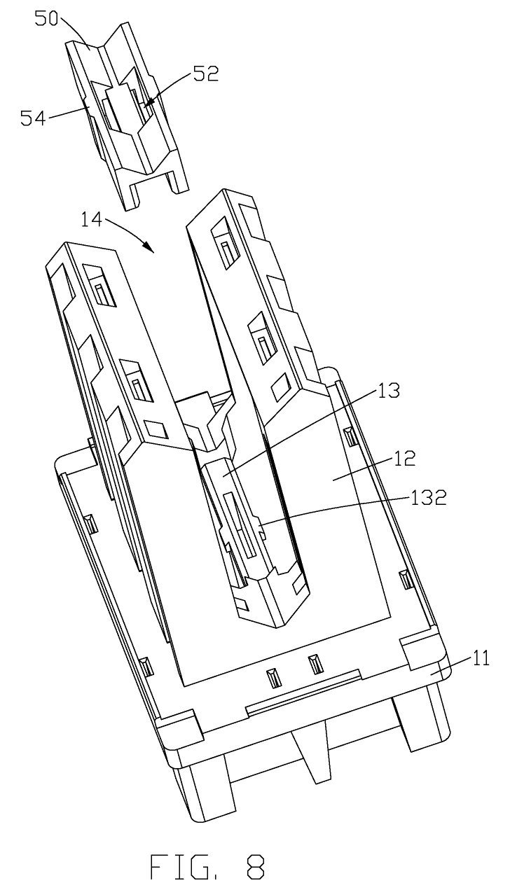

Referring to FIGS. 2 and 8, the power connector 100 may further include a stopper 50. The insulating housing 10 has a ridge 13, which may be located at one end of the base portion 11 facing the pair of sidewalls 12, and the ridge 13 is positioned between the two sidewalls 12. The ridge 13 may offer the plug-stopping face 141 of the mating slot 14. The stopper 50 is mounted on the ridge 13 and is clamped between the two conductive blocks 20. In some embodiments, the stopper 50 is made of a non-conductive insulating material, which may include but is not limited to plastic. The stopper 50 respectively abuts against the conductive blocks 20, to allow the conductive blocks 20 to be more securely combined with the sidewalls 12. The plural latches 40 and the stopper 50 at opposite ends of the conductive blocks 20 prevent the rotation or displacement of the conductive blocks 20 and the terminal pieces 30.

In some embodiments, two opposite sides of the ridge 13 respectively have locking protrusions 132 respectively facing corresponding conductive blocks 20. The stopper 50 is generally U-shaped, and the two sidewalls of the U-shape respectively have locking grooves 52. The two locking protrusions 132 are correspondingly engaged with the two locking grooves 52 respectively, allowing the stopper 50 to be mounted on the ridge 13. Therefore, the stopper 50 is prevented from shifting or displacing from the sidewall 12. The opposite sides of the stopper 50 respectively have ribs 54 facing and abutting against the conductive blocks 20 respectively, thereby enhancing the connection between the stopper 50 and the conductive blocks 20.

The power connector 100 may further include two conduction/grounding terminals 62. The conduction terminals 62 are respectively arranged on the outsides of the sidewalls 12. The plural conduction terminals 62 are used to achieve a grounding function, as conduction terminals 62 can contact the grounding components of the second connector 200 to form a grounding path.

Referring to FIGS. 2 and 9, the power connector 100 may further include a first conductive transmission member 60 and a second conductive transmission member 70. The first conductive transmission member 60 may be a power cable or a bus bar, while the second conductive transmission member 70 may have a bus bar structure and be fixed to a circuit board to allow the current of the power connector 100 to be transmitted to the circuit board through the first conductive transmission member 60 and the second conductive transmission member 70, supplying power to the components on the circuit board. The second conductive transmission member 70 may take the form of another type of electrical connector. The first conductive transmission member 60 is fixedly connected to the recessed portions 23 of the conductive blocks 20, enabling current conduction with the conductive blocks 20 respectively. In some embodiments, the first conductive transmission member 60 penetrates the base portion 11 and connects to the conductive block 20. In some embodiments, the connection between the first conductive transmission member 60 and the recessed portions 23 may, but is not limited to, be fixed by ultrasonic welding. The second conductive transmission member 70 is connected to the rear of the first conductive transmission member 60. In some embodiments, the second conductive transmission member 70 may be a pair of L-shaped metal plates that can be fixedly attached to the circuit board, thereby improving the adaptability of the power connector 100.

Referring to FIGS. 10 and 11, the power connector 100 can be connected to other electronic components, such as the second connector 200. The power connector 100 may, but is not limited to, serve as an input connector or a male connector, while the second connector 200 may, but is not limited to, serve as an output connector or a female connector. In this embodiment, the second connector 200 is a power bus bar, referred to as a Rack Bus bar.

The second connector 200 may include a base portion 210 and two side portions 220, and a middle/plug portion 230. The plug portion 230 extends from the base portion 210 and is adapted to be inserted into the mating slot 14. The base portion 210 and the middle portion 230 includes an insulating portion 241 located in the middle and two bus bars 242 located on both sides of the insulating portion 241. The insulating portion 241 has a generally V-shaped guiding face 2411.

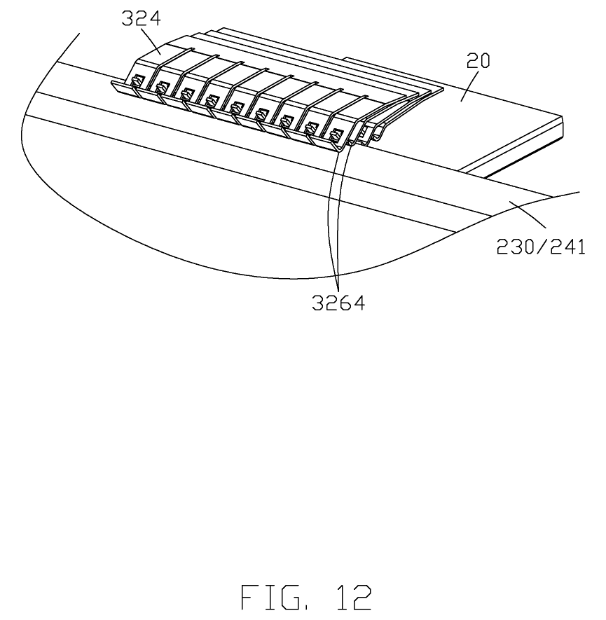

Referring to FIGS. 3-6 and 12, when the power connector 100 is connected to the second connector 200, the two side portions 220 and the middle portion 230 move in the direction from the sidewalls 12 to the base portion 11. The two side portions 220 surround the outer sides of the pair of sidewalls 12 and connect to the plural conduction terminals 62, achieving the grounding function. At the same time, the middle portion 230 passes through the space between the pair of sidewalls 12, the pair of conductive blocks 20, and the plural terminal pieces 30. The V-shaped guiding face of the middle portion 230 sequentially abuts against the contacting faces 3264 of the terminal pieces 30 corresponding to the pair of conductive blocks 20, causing the terminal pieces 30 to undergo elastic deformation. The coupling tabs 3262 of the terminal pieces 30 move within the corresponding coupling holes 3268 of the adjacent terminal pieces 30, allowing the plural terminal pieces 30 to elastically deform and make way for the middle portion 230 to pass through. This process continues until the middle portion 230 sequentially abuts and passes through the spaces between the plural terminal pieces 30, thereby achieving electrical connection between the power connector 100 and the second connector 200.

When the power connector 100 is disengaged from the second connector 200, the two side portions 220 and the middle portion 230 move in the direction from the base portion 11 to the sidewalls 12. The middle portion 230 passes through the space between the pair of sidewalls 12, the pair of conductive blocks 20, and the plural terminal pieces 30. The V-shaped guiding face of the middle portion 230 sequentially detaches from the contacting faces of the terminal pieces 30 corresponding to the pair of conductive blocks 20, allowing the terminal pieces 30 to elastically recover. The coupling ends 3262 of the terminal pieces 30 move within the corresponding coupling holes 3268 of the adjacent terminal pieces 30, enabling the plural terminal pieces 30 to elastically recover to their natural state. This process continues until the middle portion 230 sequentially detaches and passes through the spaces between the plural terminal pieces 30 and exits from between the pair of sidewalls 12. At the same time, the two side portions 220 disengage from the outer sides of the pair of sidewalls 12 and disconnect from the plural conduction terminals 62. As a result, the power connector 100 and the second connector 200 are separated.

The above-mentioned embodiments are only preferred embodiments of the present invention, and should not limit the scope of the present invention, any simple equivalent changes and modifications made according to the claims of the present invention and the contents of the description should still belong to the present invention.

1. A power connector comprising:
an insulating housing defining a mating direction, a first direction, and a second direction perpendicular to each other, the insulating housing comprising two sidewalls arranged in the first direction and having a mating slot opening forwards in the mating direction; and
two terminal assemblies disposed at insides of the sidewalls respectively, each of the conductive assemblies comprising a conductive block, a group of terminal pieces stacked in the first direction, and a power cable or bus bar;
wherein:
each terminal piece comprises a rear portion and plural elastic arms extending forwards from the rear portion and arranged in the second direction, the elastic arms having contacting portions protruding into the mating slot in the first direction;
the rear portions of the group of terminal pieces are fitly attached to an associated conductive block, and an associated power cable or bus bar is attached to the associated conductive block.

2. The power connector as claimed in claim 1, wherein the mating slot has a plug- stopping face facing forwards, the rear portions of the group of terminal pieces are attached to an inside of the conductive block and located in front of the plug- stopping face of the mating slot, the cable or the bus bar is attached to an outside of the conductive block.

3. The power connector as claimed in claim 2, wherein the conductive blocks extend forwards beyond the contacting portions of the groups of terminal pieces.

4. The power connector as claimed in claim 2, wherein the conductive block has plural step faces on the inside thereof, the rear portions of the group of terminal pieces are attached on corresponding stepped faces one by one, the rear portion and the elastic arms of the group of the terminal piece are spaced from each other in the first direction.

5. The power connector as claimed in claim 2, wherein the conductive block has a recessed portion at the outside thereof, the cables or a bus bar are fixed in the recessed portion.

6. The power connector as claimed in claim 5, wherein a front side of the recessed portion is located in front of the plug-stopping face of the mating slot.

7. The power connector as claimed in claim 1, wherein the power connector includes plural latches, the conductive block has plural first grooves, and the insulating housing has plural locking holes, and each of the latches is fixed in corresponding first groove and latched into corresponding locking hole.

8. The power connector as claimed in claim 1, wherein the power connector comprises a stopper, the insulating housing has a ridge at the plug-stopping face, and the stopper is mounted on the ridge and clamped between the two conductive blocks.

9. The power connector as claimed in claim 1, wherein each of the sidewalls has a receiving cavity at the inside thereof and opening rearwards in the mating direction, the conductive assemblies are inserted forwards into the receiving cavities respectively.

10. The power connector as claimed in claim 1, wherein:
the group of terminal pieces comprises an innermost terminal piece, an outermost terminal piece, and at least one middle terminal piece;
the innermost terminal piece has a coupling tab extending forwards from each of the contacting portion thereof;
the middle terminal piece has a coupling tab extending forwards from each of the contacting portions thereof, and a coupling hole on each of the contacting portions thereof to receive corresponding coupling tab of the innermost terminal piece; and
the outermost terminal piece has a coupling hole at each of the contacting portions thereof to receive corresponding coupling tab of the middle terminal piece.

11. A power connector comprising:
an insulating housing comprising a base portion and two sidewalls, and a mating slot defined between the two sidewalls and located in front of the base portion, each of the sidewalls has a receiving cavity communicating with the mating slot and running through the base portion; and
two conductive assemblies received in the receiving cavities respectively, each of the conductive assemblies comprising a conductive block, at least one terminal piece, and a power cable or a power bus, the terminal piece comprising a plurality of elastic arms with contacting portions protruding into the mating slot;
wherein the at least one terminal piece is fitly attached to the conductive block, the power cable or the bus bar is attached to the conductive block.

12. The power connector as claimed in claim 11, wherein the mating slot has a plug-stopping face facing forwards, the at least one terminal piece is attached to an inside of the conductive block and located in front of the plug-stopping face of the mating slot, the power cable or the bus bar is attached to an outside of the conductive block.

13. The power connector as claimed in claim 12, wherein the conductive blocks extend forwards beyond the contacting portions of the at least one terminal piece.

14. The power connector as claimed in claim 12, wherein:
the conductive block has a plurality of stepped faces on the inside thereof; and
each of the terminal assemblies comprises a plurality of the terminal pieces arranged in a first direction and attached on corresponding stepped faces one by one, and the elastic arms of the plurality of the terminal pieces are spaced from each other in the first direction.

15. The power connector as claimed in claim 12, wherein the conductive block has a recessed portion at the outside thereof, the cables or a bus bar are fixed in the recessed portion.

16. The power connector as claimed in claim 15, wherein a front side of the recessed portion is located in front of the plug-stop face of the mating slot.

17. The power connector as claimed in claim 12, further comprising a stopper, and wherein the insulating housing has a ridge at the plug-stopping face, and the stopper is mounted on the ridge and clamped between the two conductive blocks.

18. A power connector comprising:
an insulating housing defining a mating direction, a first direction, and a second direction perpendicular to each other, and having a mating slot opening forwards in the mating direction; and
a group of terminal pieces located at one side of the mating slot in the first direction, each of the terminal pieces comprising elastic arms extending forward and arranged in the second direction, each of the elastic arms having a contacting portion bent towards the mating slot in the first direction;
wherein:
the group of terminal pieces comprises an innermost terminal piece, an outermost terminal piece, and at least one middle terminal piece;
the innermost terminal piece has a coupling tab extending forwards from each of the contacting portions thereof;
the middle terminal piece has a coupling tab extending forwards from each of the contacting portions thereof, and a coupling hole on each of the contacting portions thereof to receive corresponding coupling tab of the innermost terminal piece; and
the outermost terminal piece has a coupling hole at each of the contacting portions thereof to receive corresponding coupling tab of the middle terminal piece.
